(19) United States
(12) Patent Application Publication
(10) Pub. No.: US 2004/0036586 A1
(43) Pub. Date: Feb. 26, 2004

(54) Light tracking apparatus and method

(76) Inventor: Mark Harooni, Brooklyn, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/226,738

(22) Filed: Aug. 23, 2002

(51) Int. Cl. B60Q 1/00

(52) U.S. Cl. 340/435; 180/167

(57) ABSTRACT

A light tracking apparatus mounted on a movable vehicle includes a power source for the light tracking apparatus. There is at least one light receiving means for detecting reflected light from the surface marking and surrounding background. A computing means is included for processing the difference between intense and weak reflected light from the pavement marking providing a signal indicating a significant change in light intensity, and an alarm means responding to said signal for indicating a that change in the light intensity.

A method of operating a light tracking apparatus mounted on a movable vehicle includes engaging a power source for the light tracking apparatus. The next step includes providing at least one light receiving means for detecting reflected light from the surface marking and surrounding background. A computing means is used for processing the difference between intense and weak reflected light from the pavement marking providing a signal indicating a significant change in light intensity. The final step is engaging an alarm means responding to said signal for indicating that change in the light intensity.

### FIELD OF THE INVENTION

The present invention relates to a vehicle safety device and, more particularly, to a device that tracks the position of a moving vehicle relative to its location along a road.

### BACKGROUND OF THE INVENTION

Modern highway systems have allowed passengers in vehicles to safely travel great distances. Nevertheless, a large number of vehicular accidents occur that cause significant loss of life and property. The overwhelming majority of automobile collisions are caused by driver inattention, exhaustion and falling to sleep at the wheel of a vehicle. The conditions that lead to the driver's loss of concentration allow the automobile to deviate off-course and collide with surrounding objects. The early signs of fatigue include staring blankly at the road and a reduction in the rate of eye blinking. The drivers of motor vehicles, particularly on long highway drives, are frequently stricken by fatigue and need to stop and rest in order to return to an alert condition. Frequently the driver is many miles from the nearest available and safe roadside rest stop.

There are some prior art devices and methods that have been used in an attempt to increase vehicular safety on the highway. Such devices include devices to sense indications of when the driver is becoming fatigued such as nodding of the head or erratic steering wheel movements. For example, one such invention uses glasses as part of a system to detect the sleeping driver and to provide an awakening alarm. The system attempts to use the closing of the eyes to activate an alarm signal. A timer provides a delay period between the closing of the eye and the activation of the alarm. Devices that depend on indications of sleep have been found to trigger an alarm that may be too late to be of use in preventing accidents.

In another invention described in U.S. Pat. No. 5,717,399, an obstacle detection system for vehicle use is described which utilizes a plurality of electromagnetic antennas for transmitting FM radio waves. The electromagnetic antenna has poor detection of nearby objects because of its narrow directivity. As a result, a plurality of electromagnetic antennas are necessary, within a single radar module, to provide a wide detection angle for the nearby object. The obstacle detection system receives reflected radio waves for detection of nearby objects as well as remote objects in order to cover a wide detection range. However, this involves additional and complex circuit configurations and mechanical structures with an attendant cost increase for manufacture of the system. Furthermore, when the plurality of the differently oriented electromagnetic antennas are combined into one radar module the individual antennas have to be activated sequentially to monitor individual areas one by one in the detection zone. Consequently, there is a problem with this detection method because the nearby object is detected last in the sequence. This causes a time delay in the detection response wherein the driver of the vehicle has already veered of the road.

Another obstacle detecting device projects light, ultrasonic waves or electromagnetic waves in a specified forward or backward direction to and receives reflected waves from an object or obstacle. This system is an optical distance apparatus utilizing image sensors that include a pair of first and second optics with two convex lenses disposed in a horizontally aligned relation at a prescribed distance away from each other. It is possible to detect the presence or absence of an object lying in the direction in which the ultrasonic or electromagnetic waves or light are projected. However, it is difficult to determine whether the object detected is an obstacle to the travel of the vehicle. For example, when a vehicle is travelling on a curved road, the obstacle detecting apparatus can misidentify a guide rail as an obstacle. In addition, many transmitters and receivers are required in order to determine the location and direction of an object with respect to the moving vehicle. This results in a great increase in size and costs of manufacturing the overall apparatus.

In U.S. Pat. No. 5,929,784 an invention is disclosed for determining the distance to a road lane white line marking from a travelling vehicle. This is accomplished by two imaging lenses and two light receivers each with three light sensor arrays that detect a continuous straight white line that connects only a point of maximum value in a distribution of quantity of light on each sensor array. The line image is detected only when the sensor arrays are maintained within a predetermined narrow range for a predetermined length of time. The sensors are arranged parallel to a plane perpendicular to the optical axis of the lens thus perpetuating the narrow range of the system. For example, if a white line in the road is not a solid line, such as a dotted center line or a curved white-line, the system fails to operate. The white-line detector calculates the difference in data value between two successive pixels in each sensor along its longitudinal line. This difference in value is compared to a previous value with the final outcome being a signal output. When there is a constant change from white-line to road and back again the system detects each successive dotted white line as a first time detection and recalculates the difference in data value between two successive pixels. Consequently, there can be a constant error in the final output signal. Additionally, when the white-line is curved the system is inoperative because the sensor arrays are not angled or positioned in the narrow range required for the system to operate.

What is needed is an inexpensive system that will alert drivers of any type of vehicle that the vehicle is moving outside the lane markings on any road or highway. What is further needed is a system that operates with changing road conditions.

### SUMMARY OF THE INVENTION

It is an aspect of the present invention to use existing highway or road surface markings to detect the position of a moving vehicle relative to those surface markings.

It is yet another aspect of the present invention to provide a light tracking apparatus for moving vehicles.

It is still another aspect of the present invention to provide a light tracking apparatus for vehicles that is both inexpensive to manufacture and simple to operate.

To accomplish these and other aspects a light tracking apparatus mounted on a movable vehicle includes a power source for the light tracking apparatus. There is at least one light receiving means for detecting reflected light from the surface marking and surrounding background. A computing means is included for processing the difference between intense and weak reflected light from the pavement marking providing a signal indicating a significant change in light intensity, and an alarm means responding to said signal for indicating a that change in the light intensity.

A method of operating a light tracking apparatus mounted on a movable vehicle includes engaging a power source for the light tracking apparatus. The next step includes providing at least one light receiving means for detecting reflected light from the surface marking and surrounding background. A computing means is used for processing the difference between intense and weak reflected light from the pavement marking providing a signal indicating a significant change in light intensity. The final step is engaging an alarm means responding to said signal for indicating that change in the light intensity.

These and other aspects of the claimed invention will become apparent from the following description, the description being used to illustrate a preferred embodiment of the claimed invention when read in conjunction with the accompanying drawings.

### BRIEF DESCRIPTION OF THE DRAWINGS

FIG. 1 shows a block diagram of the whole configuration of the preferred embodiment of the invention.

FIG. 2 is the logic diagram used to provide microprocessor software to operate the preferred embodiment of the invention.

FIG. 3 shows the preferred embodiment of the invention positioned in a vehicle on a highway.

FIG. 4 shows the operation of the light detector portion of the preferred embodiment of the invention.

FIG. 5 is a detailed portion of the scanning area of the light sensor in the preferred embodiment of the invention.

### DETAILED DESCRIPTION OF THE INVENTION

While the claimed invention described below references tracking moving vehicles, a practitioner in the art will recognize the principle of the claimed invention are applicable elsewhere, for example, mobile equipment and the like.

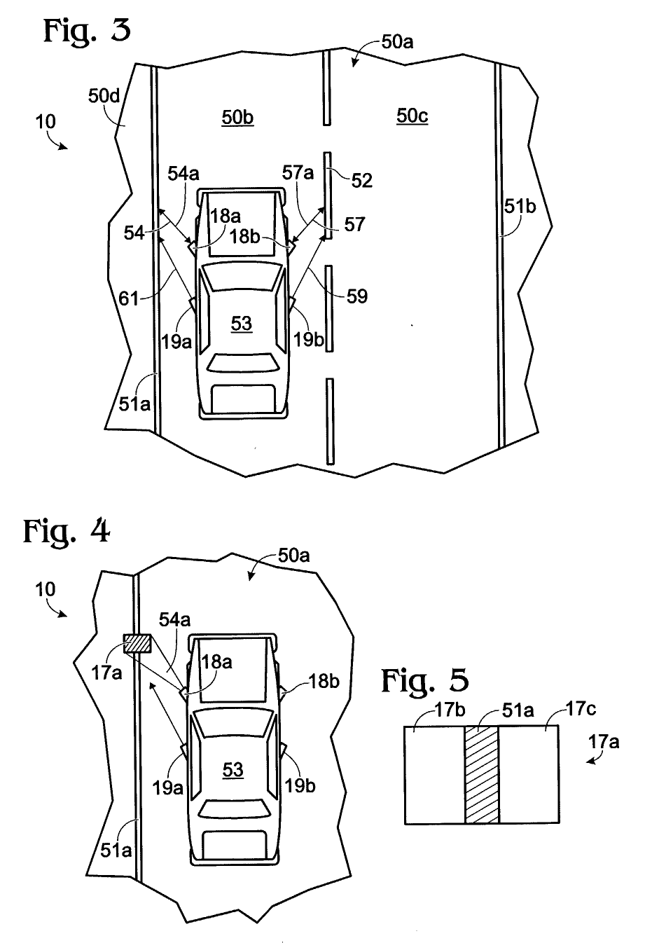

As can be seen in FIG. 3 one feature of highways is the pavement markings 51a, 52 and 51b that separate a first lane 50b from the second lane 50c and from the shoulder 50d of the highway 50a. A vehicle 53 travelling properly within a lane in a highway 50a maintains a given distance from these pavement marks. As long as the vehicle 53 is properly driven, the first distance 54 from the first pavement marking 51a and the second distance 57 from the second pavement marking 52 is constant within a tolerance interval. There are only limited situations in which a vehicle's distance from any pavement markings would vary substantially. For example, a vehicle makes a planned lane change, a vehicle is exiting a highway, a vehicle stops at the shoulder of the highway, a vehicle is inattentively driven or the pavement marks are absent. A vehicle 53 is typically a passenger automobile, a truck, a bus, mobile equipment or a recreation vehicle.

The pavement markings as shown in FIG. 4, being either yellow or white in color or are reflectors that reflect a greater amount if incident light compared to the surround asphalt or concrete. The first surface area 17a, in FIG. 5, comprises a left side background 17b of the first pavement marking 51a and a right side background 17c of the first pavement marking 51a. The intensity of light reflected from the first pavement marking 51a is greater that the gray background of the left side 17b and the right side 17c. A first light sensor 18a is mounted on vehicle 53 and positioned to provide a first sensor measurement 54a of the first surface 17a. The first light sensor 18a measures reflected light from the first surface area 17a and either detects the presence of the first pavement marking 51a or does not detect the presence of the first pavement marking 51a, depending on the position of vehicle 53 on the highway 50a. As is shown in FIG. 3 and FIG. 4 a second light sensor 18b is also positioned on vehicle 53 to provide a second sensor measurement 57a of an area around the second pavement marking 52. As is understood by the practitioner in the art, the light tracking apparatus 10 functions with one, two, three, four or more light sensors, depending on the application, to measure the reflected light intensity of the pavement surface markings. Furthermore, a first light source 19a directs light to a first pavement marking 51a and a second light source 19b directs light to a second pavement marking 52 when needed for the first and second light sensors to detect reflected light. The light sources are typically required during night driving of the vehicle. Alternately, in conjunction with the same number of light sensors, the light tracking apparatus 10 functions with one, two, three, four or more light sources.

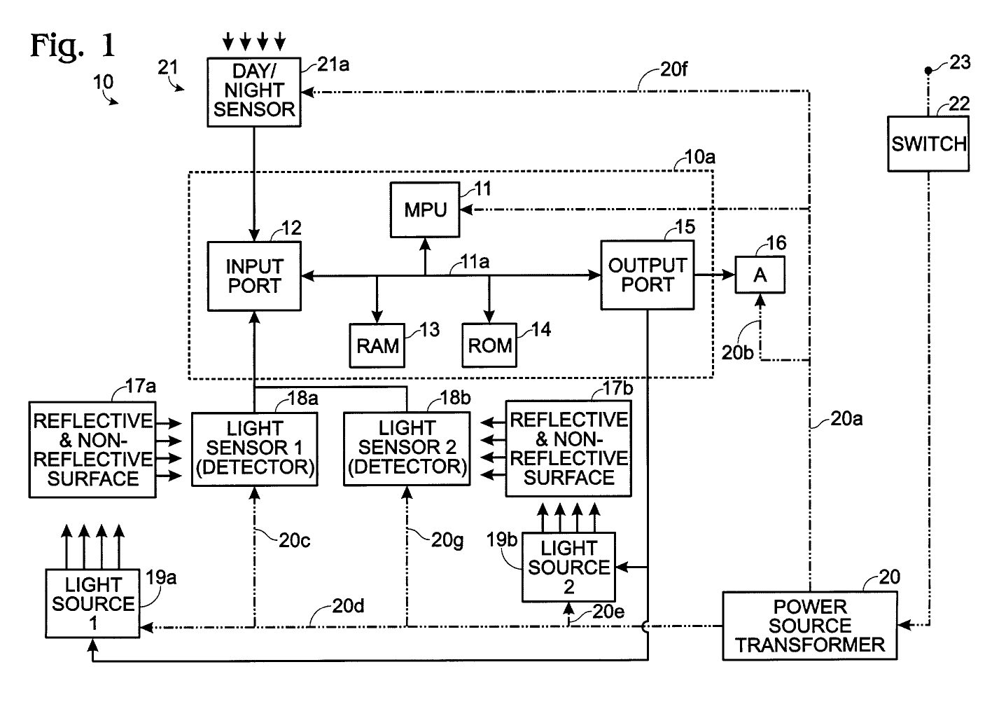

Now referring to FIG. 1, it shows the whole configuration of the light tracking apparatus 10. A controller 10a includes a microprocessor and its peripheral devices. The microprocessor includes a MPU 11 (microprocessor unit), a RAM 13 (random access memory), a ROM 14 (read only memory), an input port 12, an output port 15 and a common bus 11a. A first light source 19a and a second light source 19b provide a regulated amount of light beamed directly at the pavement markings and surrounding background of a road, highway or the like. A first light sensor 18a and a second light sensor 18b each provide a signal to the controller 10a, by measuring reflected light from pavement markings on a road, highway or the like where the light source was directed to. A power source transformer 20 provides DC voltage to apparatus 10. A switch 22 is provided to turn the system on and off. A day/night sensor 21 determines if there is enough background light for apparatus 10 to operate and provides a control signal to operate the first light source 19a and the second light source 19b. Finally, an alarm 16 is provided that activates when not enough reflected light is measured by the first light sensor 18a and the second light sensor 18b. In other words when vehicle 53 in FIG. 3 veers off of highway 50a then the light tracking apparatus 10 activates alarm 16 to alert the driver.

The power source 23 for energizing the components of the light tracking apparatus is typically obtained from the 12 volt DC battery of an automobile or other type of vehicle. In other applications the DC voltage is substitutable for AC power obtained from 110 volt AC outlet. In yet another application DC voltage is obtainable from photovoltaic cells mounted on a vehicle. In any application a power source transformer 20 is provided to allow apparatus 10 to operate as a low voltage system. Low voltage electrical energy is provided at a MPU 11 through a first circuit 20a, an alarm 16 through a second circuit 20b, a day/night sensor 21a through a sixth circuit 20f, a first light source 19a through a fourth circuit 20d and a second light sources 19b through a fifth circuit 20e. Furthermore, low voltage electrical energy is provided at a first light sensor 18a and a second light sensor 18b through a third circuit 20c and a seventh circuit 20g, respectively. Typically, the power transformer 20 is a single transformer but the single transformer is substitutable for a number of transformers individually providing low voltage power to the different components of apparatus 10.

The switching means 22 consists of a manual on-off toggle device to engage (activate) or disengage (deactivate) the light tracking apparatus 10. In the preferred embodiment of the invention the switching means 22 further consists of a vehicle's turn-signal indicator switch device. When a driver is making a conscious lane change, the alarm 16 is temporarily deactivated so that it will not result in sounding the alarm 16. Alternately, a photo sensitive switch device (not shown) is incorporated into the light tracking apparatus 10 so as not to allow it to operate during day light hours. As is known by the practitioner in the art, the switching means 22 is a variety of devices that engage/disengage power to apparatus 10.

A light emitting means consists of a first light source 19a and a second light source 19b. Alternately the light emitting means consists of one, two, three, four or more light sources to provide an adequate amount of light for apparatus 10 to operate. For example, the light emitting means might consist of two sets of three light sources on each side of a vehicle. If one light source were to malfunction then the other light sources would be adequate for continued operation of the apparatus 10. The light emitting means of the preferred embodiment of the invention projects light onto a pavement marking and surrounding background. Typically the light emitting means is activated only during the night when it is dark. It provides light so that the light sensors measure intense reflected light from the pavement marking and weak reflected light from the surrounding background.

It is a feature of the light sources that they are typically a wide variety of light sources such as incandescent bulb, light emitting diode and infra-red. For example, the first light source 19a and second light source 19b can produce light in either the visible or infrared portion of the light spectrum. Regardless of the particular light source used, the light source is typically powered from a DC power source that is low voltage such as 12 volts. The light source is operated at times of low light conditions so that the proper amount of light is reflected from the first surface 17a and the second surface 17b, respectively, to the first light sensor 18a and the second light sensor 18b.

Regardless of the number or type of light sources used, each light source is separately mounted on one side of vehicle 53 and the opposite side of vehicle 53. Preferably, the light sources are mounted and aligned so that the incident angle of light will reflect back to the light sensors from the pavement markings in the first surface 17a and the second surface 17b. That is to say that the light emitted from the first light source 19a provides a beam of light with a first angle of incidence 61 and the light emitted from the second light source 19a provides a beam of light with a second angle of incidence 59. The first light sources 19a with the first angle of incidence 61 and the second light source 19b with the second angle of incidence 59, as shown in FIG. 3, is directed respectively to the first pavement marking 51a and the second pavement marking 52. These angles of incidence are such that the reflected light from the first and second pavement marking, respectively, are measured by the first light sensor 18a and the second light sensor 18b. It is very important to achieve the correct first angle of incidence 61 and the second angle of incidence because of vehicle headlights from other vehicles on highway 50a. One reason for this is because approaching vehicle headlights create a spot in the highway surface diffusing reflection from the surface markings causing erroneous measurement of the first light sensor 18a and/or the second light sensor 18b.

A light receiving means for detecting gradations of intensities of incident reflected light from the pavement marking and surrounding background includes a first light sensor 18a and a second light sensor 18b. Alternately the light receiving means consists of one, two, three, four or more light sensors to detect an adequate amount of reflected light for apparatus 10 to operate. Typically the light receiving means is an infra-red sensor, an optical sensor, silicon photodetectors or retroflective sensors. The first light sensor 18a receives reflected light from a first surface area 17a while the second light sensor 18b receives reflected light from a second surface area 17b. As long as the first sensor 18a and the second sensor 18b continue to measure uniform reflected light, the relative distances, that is the first distance 54 and the second distance 57 and/or the incidence of light upon the sensors, is the same. If the first sensor 18a and/or the second sensor 18b suddenly measures (detects) reflected light intensity substantially lower than previously measured (detected), then the position of the sensors relative to the pavement markings must have changed. In such an instance, the assumption would be that vehicle 53 has veered out of its first lane 50b into either the second lane 50c or the shoulder 50d of highway 50a.

In one embodiment of the invention, in a situation where a driver is operating the vehicle 53 along a solid first pavement marking 51a, single sensor the first light sensor 18a mounted on the vehicle 53 will suffice. The first light sensor 18a will be positioned on vehicle 53 such that the sensing angle would correspond to the position of the first pavement marking 51a. However, in more complicated driving conditions, when pavement markings are less predictable and when precise positioning of the vehicle 53 is desired, apparatus 10 includes a first light sensor 18a and a second light sensor 18b. Typically, the first light sensor 18a is located on one side of the vehicle 53 and the second light sensor 18b is located on the opposite side of the vehicle 53. The first light sensor 18a measures reflected light from the first pavement marking 51a while the second light sensor 18b measures reflected light from the second pavement marking 52. Furthermore, if for example, the second pavement marking 52 is a broken line separating the first lane 50b from the second lane 50c of highway 50a, the second sensor 18b will still properly measure the position of vehicle 53 within the first lane 50b. This is accomplished by measuring reflected light and providing a signal to the MPU 11 that is programmed to report an average intensity of light. Alternately, the second light sensor 18b and a third light sensor (not shown) are positioned on same side of vehicle 53. They face the broken second pavement marking 52 but are angled differently such that the second light sensor 18b is measuring the broken second pavement marking 52 and the third light sensor (not shown) is detecting in between the broken second pavement marking 52. Thus one sensor is always reporting an intensity of light.

The light receiving means first light sensor 18a and second light sensor 18b are operated on 12 volts, direct current, having a range between 2 feet and 10 feet, a beam spread of 20° or so and an angle of tilt of plus or minus 10° or so. It functions like a simple rheostat switch by moving between a normally open position when no reflection of light is detected and a closed position when the reflection of light is detected. The fully open position prevents the passage of electrical energy therethrough while the fully closed position allows the passage of electrical energy therethrough. In between are various values of electrical energy that provide the MPU 11 with a signal for the apparatus 10 to operate.

The light receiving means first light sensor 18a and second light sensor 18b has two or more distinct range sensitivity that is automatically selected by controller 10a to thereby vary the reach of the sensors. The sensors have a short range sensitivity selection to detect the first surface area 17a and/or second surface area 17b that is between 2 feet and 4 feet. Alternately, the sensors have a long range sensitivity selection to detect the first surface area 17a and/or the second surface area 17b that is between 4 feet and 10 feet.

The light receiving means further includes a day/night detection circuitry 21. The day/night detection circuitry 21 includes a day/night light sensor 21a for detecting whether or not there is adequate amount of background light for apparatus 10 to operate without a light emitting means. In other words, does the day light provide enough light so the light receiving means detects the reflected light from the first payment marking 51a and the second payment marking 52. The day/night light sensor 21a provides a signal to the MPU 11 to either activate or deactivate the light emitting means. The day/night detection circuitry further controls and varies the intensity of light emitted from the light emitting source in conditions that do not either fully activate or deactivate the light emitting source, that is like cloudy day light hours.

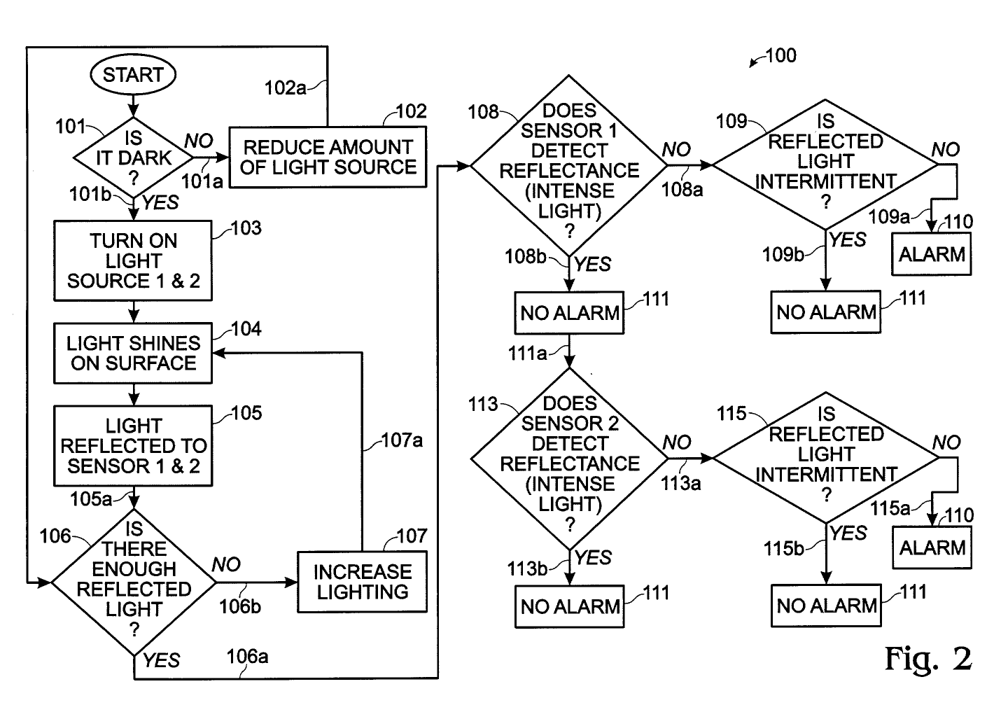

An alarm means that is an alarm 16 indicates a change in the position of vehicle 53 that is veering off highway 50a. The alarm 16 receives a signal from the controller 10a that the first light sensor 18a and/or the second light sensor 18b is no longer measuring enough reflected light from either the first pavement marking 51a and/or the second pavement marking 52. Typically the alarm 16 is an electronic alarm beeping out pulsating sound waves. These sound waves are strong enough for the driver of vehicle 53 to notice hear the sound waves and notice the vehicle 53 is veering off the highway 50a. Alternately, the electronic alarm 16 is substitutable for a siren, horn or flashing light The computing means includes controller 10a with a MPU 11, a RAM 13, a ROM 14 and common bus 11a. The computing means further includes a software structure 100, as shown in FIG. 2, of the controller 10a The computing means processes the difference between intense (strong) and not so intense (weak) reflected light received from the pavement markings and surrounding background. A signal is provided to alarm 16 indicating a significant change in the light intensity, that in other words shows the driver of vehicle 53 is veering of the highway 50a.

In FIG. 2, software structure 100 provides the necessary logic for programming apparatus 10 to operate. The software structure 100 at a first decision 101 determines whether there is enough natural light to operate. If the first path 101a is chosen then the first step 102 deactivates or reduces the amount of light being emitted from the first light source 19a and the second light source 19b. If the second path 101b is chosen then the second step 103 activates and/or increases the amount of light emitted from the first light source 19a and the second light source 19b. When the first step 102 reduces the amount of emitted light from the light sources a third path 102a is chosen and a second decision 106 determines whether there is enough reflected light from the first pavement marking 51a and the second pavement marking 52. When the second step 103 activates or increases the amount of light emitted from the light source, it follows that in the third step 104 the light is directed to the first surface 17a and the second surface 17b. The directed light is then reflected in the fourth step 105 from the first pavement marking 51a and the second pavement marking 52. The fourth step 105 reflects light measured by the light receiving means and proceeds through a fourth path 105a to a second decision 106 that determines whether enough light is being reflected for apparatus 10 to operate.

The second decision 106 determines whether enough light is being reflected for apparatus 10 to operate. If a fifth path 106a is chosen then the third decision 108 determines whether the first light sensor 18a detects a reflectance. If a sixth path 106b is chosen then a fifth step 107 proceeds through the seventh path 107a to increase the amount of light emitted from the light sources so that a certain intensity of light is reflected to the first light sensor 18a and the second light sensor 18b as provided in the third step 104 and the fourth step 105.

When the third decision 108 does not detect reflected light the eighth path 108a is taken to a fourth decision 109 that determines whether the reflected light is intermittent. If the reflected light is determined not to be intermittent than a tenth path 109a is taken and activates an alarm 110 indicating that the driver is veering of the road. If the reflected light is determined to be intermittent than an eleventh path 109b is taken not activating the alarm 111. When the third decision 108 detects reflected light is takes the ninth path 108b and no alarm 111 is activated. The twelfth path 11a is taken to the fifth decision 113 that determines if the second sensor detects reflected light.

When the fifth decision 113 does not detect reflected light the thirteenth path 113a is taken to a sixth decision 115 that determines whether the reflected light is intermittent. If the reflected light is determined not to be intermittent than a fifteenth path 115a is taken and activates an alarm 110 indicating that the driver is veering of the road. If the reflected light is determined to be intermittent than a sixteenth path 115b is taken not activating the alarm 111. When the fifth decision 113 detects reflected light is takes the fourteenth path 113b and no alarm 111 is activated.

The programing structure 100 is incorporated into the controller 10a of apparatus 10. At the first decision 101 a subroutine is executed. In details, the MPU 11 of the controller 10a determines whether or not there is enough background light for the first sensor 18a and the second sensor 18b to operate without a light source. That is to say the day/night sensor 21a measures how much background light is present sending a signal to the MPU 11. The subroutine of MPU 11 determines, based upon pre-loaded information into ROM 14, if there is enough background light to receive minimal reflected light from the surface markings to be measured by the first and second sensors.

If there is not enough light then the MPU 11 sends a signal activating the first light sources 19a and the second light source 19b. However, if the day/night sensor 21a measures to much light then the MPU 11 activates the first step 102 and reduces the amount of light being sent from the first light source 19a and the second light source 19b.

At the subsequent second decision 106 the MPU 11, through a subroutine and using pre-loaded information from ROM 14, decides whether there is enough light being reflected for the first and second sensors to operate. If there is not enough light then the MPU 11 activates the fifth step 107 and increases light to the surface markings from the light sources. As is understood by the practitioner in the art, the subroutine used by MPU 11 with programming structure 100 further receives a signal from stored data in ROM 14. The MPU 11 provides a proper intensity range modulation so that it does not allow the light sources to be continuously activated and deactivated wherein erroneous reflected light or lack thereof would be measured by the light sensors.

Once the controller 10a has adjusted the light source within a proper range so that the light sensors correctly measure the reflected light from the surface markings, the MPU 11 with its subroutine, RAM 13 and ROM 14 now determine if the reflectance measured by the sensors indicate whether the vehicle is veering off the road. The controller 10a receives a signal from the light sensors through the common bus 11a that feeds information to MPU 11. As long as the light sensors continue to measure a uniform reflection of light, that is to say, the relative distance and/or angle of incidence of reflected light does not change, the subroutine of MPU 11 does not activate the alarm 16. If the light sensors suddenly measure reflected light intensities substantially lower than previously measured then the subroutine of MPU 11 activates the alarm 16. The subroutine allows MPU 11 to compare actual data signals received from the light sensors to recent reflected light data signals that are previously stored in the RAM 13. The comparison, for example, enables the MPU 11 to not erroneously detect a broken pavement marking, such as a broken center line on a highway, through an algorithm stored in the ROM 14 that performs a calculation averaging the reflected light intensity. As can be seen in FIG. 2, the programming structure 100 used in the subroutine directs the MPU 11 to first determine whether the first light sensor is measuring reflected light and then directs the MPU 11 to determine whether the second light sources is measuring reflected light. In this way the alarm will be activated when the vehicles veers off the road in either direction.

A light tracking apparatus is typically installed on a moving vehicle such as an automobile. A DC power source is engaged to energized the components of the light tracking apparatus. When the driver of the automobile starts it by turning on the ignition a power source engages the light tracking apparatus. The driver then can turn on or off a switch in the automobile to activate or deactivate the light tracking apparatus. Also, if the light tracking apparatus is activated, the driver can temporarily deactivate the light tracking apparatus by using a turn signal in the automobile when, for example, the driver wants to turn off the road or make a lane change. At least one light emitting means provides light projected onto a pavement marking and the surrounding background of the road. At least one light receiving means provides measurement of reflected light received from the pavement marking and surrounding background of the road. A computing means is used to process the difference between intense and weak reflected light providing a signal indicating a significant change in light intensity. Finally, an alarm means is engaged when there is a significant change in light intensity.

While there has been illustrated and described what is at present considered to be the preferred embodiment of the claimed invention, it will be appreciated that numerous changes and modifications are likely to occur to those skilled in the art. It is intended in the appended claims to cover all those changes and modifications that fall within the spirit and scope of the present invention.

What is claimed is:

1. An apparatus mounted on a movable vehicle comprising:
a) a power source for energizing the components of said apparatus;
b) at least one light receiving means for detecting reflected light from a pavement marking and the surrounding background;
c) a computing means for processing the difference between the light reflected from said pavement marking and the light reflected from said background providing a signal indicating a change in light intensity; and
d) an alarm means responding to said signal for indicating a change in said light intensity.

2. The apparatus as claimed in claim 1, further comprising a switching means for activating/deactivating said light tracking apparatus.

3. The apparatus as claimed in claim 1, further comprising at least one light emitting means for projecting said light onto at least one pavement marking and surrounding background.

4. The apparatus as claimed in claim 2, wherein said switching means is a plurality of devices.

5. The apparatus as claimed in claim 1, wherein said light receiving means is a plurality of sensors measuring reflected light intensity.

6. The apparatus as claimed in claim 1, wherein said alarm means is a plurality of devices providing a pulsating output.

7. The apparatus as claimed in claim 1, wherein said computing means determines the average light intensity of a broken pavement marking.

8. The apparatus as claimed in claim 1, wherein said light receiving means further includes circuitry to operate either in the night or the day.

9. The apparatus as claimed in claim 3, wherein said light emitting means is a plurality of light producing devices.

10. A method of operating an apparatus mounted on a movable vehicle comprising:
a) engaging a power source for energizing the components of said apparatus;
b) providing at least one light receiving means for detecting reflected light from a pavement marking and the surrounding background;
c) using a computing means for processing the difference between intense reflected light from said pavement marking and weak reflected light from said background providing a signal indicating a significant change in light intensity; and
d) engaging an alarm means responding to said signal for indicating a significant change in said light intensity.

11. The method of operating an apparatus as claimed in claim 10, further comprising a switching means for activating/deactivating said light tracking apparatus.

12. The method of operating an apparatus as claimed in claim 10, further comprising at least one light emitting means for projecting said light onto at least one pavement marking and surrounding background.

13. The method of operating an apparatus as claimed in claim 11, wherein said switching means is a plurality of devices.

14. The method of operating an apparatus as claimed in claim 10, wherein said light receiving means is a plurality of sensors measuring reflected light intensity.

15. The method of operating an apparatus as claimed in claim 10, wherein said alarm means is a plurality of devices providing a pulsating output.

16. The method of operating an apparatus as claimed in claim 10, wherein said computing means determines the average light intensity of a broken pavement marking.

17. The method of operating an apparatus as claimed in claim 10, wherein said light receiving means further includes circuitry to operate either in the night or the day.

18. The method of operating an apparatus as claimed in claim 12, wherein said light emitting means is a plurality of light producing devices.
